(19) United States
(12) Patent Application Publication
(10) Pub. No.: US 2006/0088699 A1
(43) Pub. Date: Apr. 27, 2006

(54) Structure of decoration article

(76) Inventor: Ming-Hsiang Yeh, Taipei City (TW)

Correspondence Address: TROXELL LAW OFFICE PLLC;SUITE 1404, 5205 LEESBURG PIKE, FALLS CHURCH, VA, 22041, US

(21) Appl. No.: 10/969,987

(22) Filed: Oct. 22, 2004

(51) Int. Cl. B41M 5/00

(52) U.S. Cl. 428/195.1

(57) ABSTRACT

An improved structure of a decoration article is disclosed. The decoration article mainly comprises a decoration body, which is a media player, wherein the media player comprises a plurality of function buttons, a microphone, a camera lens, a speaker, a storage device, and an input/output device. Moreover, a connection part is mounted on the backside of the decoration body for integrating with clothing and other articles of daily use. In this way, a beautiful decoration article is formed and the decoration article can be used as a leisure time entertainment article.

### BACKGROUND OF THE INVENTION

The present invention relates to an improved structure of a decoration article that is used to listen to music, take photograph and film, or make audio recording. The decoration article is applied to a necktie clip, a pin, a nameplate, or the like.

Since Tape Walkman or CD Walkman has larger size and requires to change tape or CD if necessary. Therefore, MP3 player gradually replaces the Walkman because the MP3 player is small and light. The most important feature of the MP3 player is that it does not need to change tape or CD. The content of the MP3 can be updated by merely downloading MP3 music or MP3 music conversion via the computer. Moreover, the MP3 player can be applied to audio recording. As a result, the MP3 player is very convenient and practical.

However, most of the general MP3 players disclosed by, for example, Taiwan patent publication no. 544,064, entitled “portable music player having multicolor display function” and Taiwan patent publication no. 566,794, entitled “digital music playing audio”, etc, are merely used to show music or make audio recording, and have no other functions.

In view of the above circumstances, the present inventor has been made diligent studies with a quiet mind to design and fabricate an improved structure of a decoration article that enables user to listen to music, take photograph and film, or make audio recording. Besides, the decoration article can be used to beautify appearance. This decoration article is provided for the consumer in accordance with motivations of the present invention.

### SUMMARY OF THE INVENTION

The primary purpose of the present invention is to provide an improved structure of a decoration article that has beautiful appearance. The decoration article can be used to listen to digital music, take photograph and film, or make audio recording.

The secondary purpose of the present invention is to provide an improved structure of a decoration article that acts as a nameplate rack, a laser pointer, and an entrance control card such that the user does not need to carry multifarious articles.

According to the aforementioned purposes of the present invention, an improved structure of a decoration article is disclosed. The decoration article mainly comprises a decoration body, wherein the decoration body is a media player on which a plurality of function buttons, a microphone, a camera lens, a speaker, a storage device, and an input/output device are mounted. Moreover, a connection part is mounted on the backside of the decoration body for integrating with clothing and other articles of daily use. In this way, a beautiful decoration article, which is used as a leisure time entertainment article, is formed. Moreover, the decoration article can be used as an entrance control card and a laser pointer.

The other features and preferred embodiments of the present invention will now be described with reference to the accompanying drawings.

### BRIEF DESCRIPTION OF THE DRAWINGS

FIG. 1 is a perspective view showing appearance of a preferred embodiment of the present invention.

FIG. 2 is a perspective view in another direction showing appearance of a preferred embodiment of the present invention.

FIG. 3 is a perspective view showing appearance of a second preferred embodiment of the present invention.

FIG. 4 is a perspective view showing appearance of a third preferred embodiment of the present invention.

### DETAILED DESCRIPTION OF THE PREFERRED EMBODIMENT

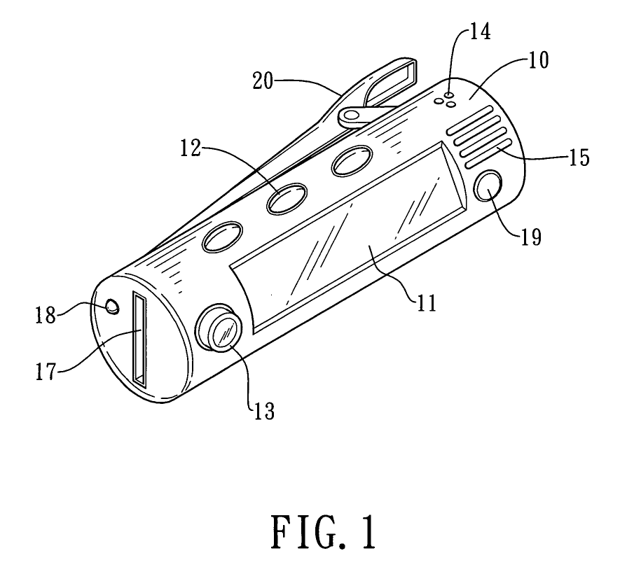

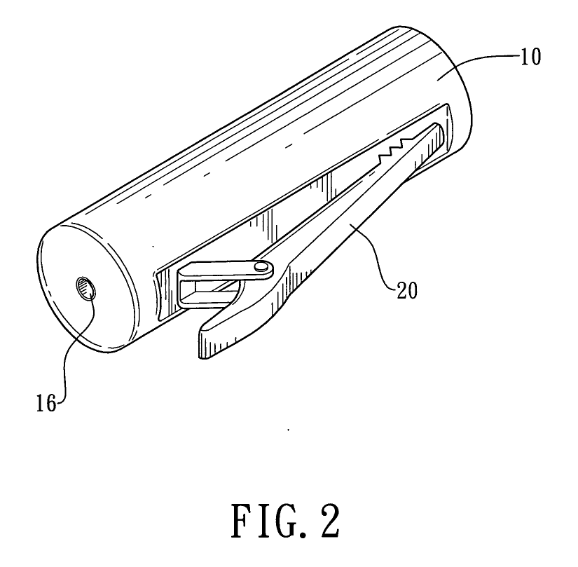

Referring to FIG. 1 and FIG. 2, the decoration article of the present invention mainly comprises a decoration body 10 and a connection part 20. A monitor 11, a plurality of function buttons 12, a camera lens 13, a microphone 14, a speaker 15, an earphone jack 16, a storage device slot 17, a LED light 18, and an identifier 19 are mounted on the decoration body 10. The connection part 20 is mounted on the backside of the decoration body 10. The connection part 20 can be a clip, a pin, or the like.

A central processing unit (CPU) is mounted on the inside of the decoration body 10, wherein the CPU is further connected to an analog to digital converter, a digital to analog converter, an audio amplifier, a digital signal processor, a transmission interface so as to form a MP3 playing circuit, and the CPU is further connected to the camera lens 13 and a Bluetooth chip module. Moreover, the identifier 19, which is mounted on the decoration body 10, is a Radio Frequency Identification (RFID) system. In this way, the entire structure described above forms a necktie clip.

The decoration body 10 is bonded to the necktie by using the clip mounted on the connection part 20 to provide user with a beautiful decoration article. During the trip to the working place, a hand-free mobile phone handset having a microphone can be plugged into the earphone jack 16 of the decoration body 10. In normal condition, when the switch of the decoration body 10 is turned on, the handset will broadcast digital music stored in the decoration body 10. If there is an incoming call for the user who carries the mobile phone, the decoration body 10 will change automatically from the status of showing music to the status of answering call once the Bluetooth chip module receives a signal of the incoming call. Therefore, the user will not miss the timing to answer the call because it is not necessary for the user to look for the mobile phone. After the user reaches the working place, a card reader can access RFID identification codes stored in the identifier 22 of the decoration body 10 so as to open the door panel thereby achieving the purpose of entrance control.

Furthermore, the LED light 18 mounted on the decoration body 10 is a laser pointer, which is applied to a meeting or a briefing. By pressing the function buttons 12, recording of published content in the meeting or the briefing can be made. Besides, by means of the camera lens 13, the decoration body 10 can be used to take photograph and film or as a network camera.

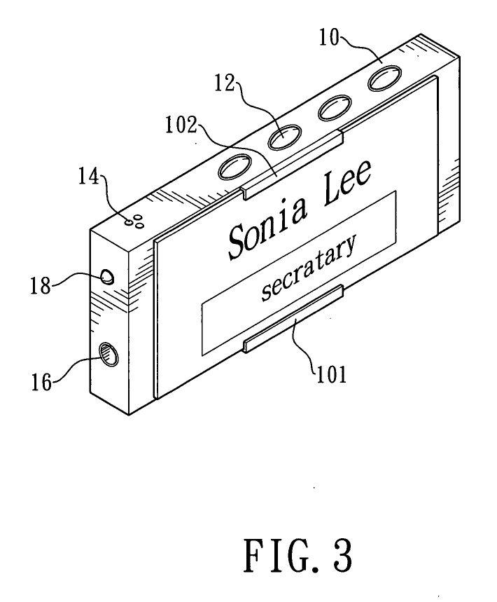

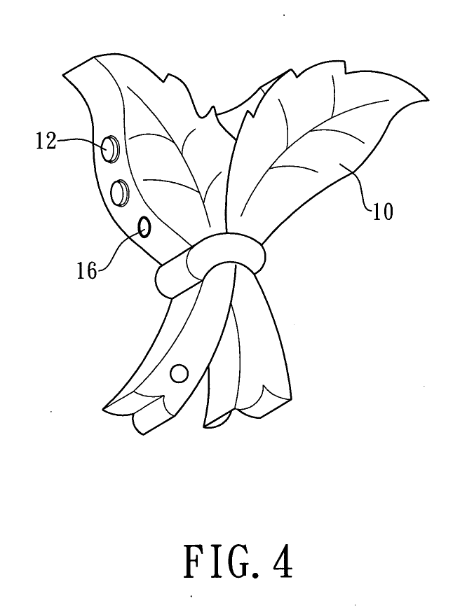

Referring to FIG. 3, two securing devices 101 and 102 for receiving a nameplate of the user are mounted on opposing peripheral edges on the surface of the decoration body 10. In the other hand, the decoration body 10 can be made in the beautiful form of a water drop, a flower, etc, as shown in FIG. 4. The decoration article becomes a decoration pin by connecting the connection part 20 to the clothing.

However, the above description merely illustrates the preferred embodiments of the present invention, and the applicable scope of the present invention is not limited hereto. Any obvious modification and revision made by a person skilled in the art are included within the spirit and scope of the present invention.

As described above, the present invention provides an improved structure of a multifunction decoration article that can be used to decorate outward appearance and listen to digital music, take photograph and film, make audio recording, etc. Besides, the decoration article can be used as an entrance card and a laser pointer. The application that complies with utility is therefore submitted for a patent.

What the invention claimed is:

1. An improved structure of a decoration article comprising:
a decoration body, wherein the decoration body is a media player on which a plurality of function buttons, a monitor, a LED light, an identifier, a microphone, a camera lens, a speaker, a storage device, and an input/output device are mounted, and
a connection part mounted on the backside of the decoration body for integrating with clothing.

2. The improved structure of the decoration article of claim 1, wherein the identifier mounted on the decoration body is a radio frequency identification (RFID) system.

3. The improved structure of the decoration article of claim 1, wherein a Bluetooth chip module is mounted inside the decoration body.

4. The improved structure of the decoration article of claim 1, wherein the connection part is a clip.

5. The improved structure of the decoration article of claim 1, wherein the connection part is a pin.

6. The improved structure of the decoration article of claim 1, wherein securing devices for receiving a nameplate are mounted on two opposing peripheral edges on a front side of the decoration body.
